(19) United States
(12) Patent Application Publication
(10) Pub. No.: US 2025/0297856 A1
(43) Pub. Date: Sep. 25, 2025

(54) Measurement System

(71) Applicant: Carl Zeiss Industrielle Messtechnik GmbH, Oberkochen (DE)

(72) Inventors: Nils Eckardt, Plüderhausen (DE); Felix Steparsch, Ulm (DE); Moritz Proell, Passau (DE)

(21) Appl. No.: 19/086,642

(22) Filed: Mar. 21, 2025

(30) Foreign Application Priority Data
Mar. 22, 2024 (DE) 102024108263.1

(51) Int. Cl. G01B 21/04; G01B 5/008; G01B 11/30

(52) U.S. Cl. CPC G01B 21/047; G01B 5/008; G01B 11/30

(57) ABSTRACT

A method for controlling a measurement system including a measurement object holder and a measurement sensor. The measurement sensor defines a reference point for measuring the measurement object and can be moved relative to the measurement object holder along multiple movement axes for measuring multiple measurement points of a measurement object. The method includes determining at least one of multiple permissible measurement directions and multiple permissible measurement positions of the measurement sensor. The method includes determining multiple permissible axis positions of at least one movement axis of the movement axes for each of the measurement points. The method includes determining an optimal axis position of the at least one movement axis for each of the measurement points from the permissible axis positions previously determined for the respective measurement point.

### CROSS-REFERENCE TO RELATED APPLICATIONS

This application claims priority to German Patent Application No. 102024108263.1 filed Mar. 22, 2024, the entire disclosure of which is incorporated by reference.

### FIELD

This disclosure relates to a method for controlling a measurement system for determining dimensional and/or geometric properties of a measurement object. This disclosure further relates to a computer program product having program code which is configured to carry out the method. Still further, this disclosure relates to a measurement system for determining dimensional and/or geometric properties of a measurement object.

### BACKGROUND

Examples of such measurement systems are coordinate measuring machines or roughness measuring devices.

Coordinate measuring machines are used, for example, to check the geometry of a workpiece as part of quality assurance or to determine the geometry of a workpiece (e.g. as part of “reverse engineering”). A method for controlling a coordinate measuring machine and a coordinate measuring machine are known, for example, from DE 10 2019 110 508 A1.

In coordinate measuring machines, various types of sensors are used to capture dimensional and geometric properties of the measurement object. In principle, the sensors of coordinate measuring machines can be divided into sensors that carry out tactile measurement and sensors that carry out optical measurement. Coordinate measuring machines that use both tactile and optical sensors are also referred to as “multi-sensor coordinate measuring machines”.

In the case of tactile sensors, the surface of the measurement object is scanned selectively by touching or continuously as part of so-called scanning with a probe pin or probe sphere. The probe is positioned at each measurement point for this purpose. Additionally or alternatively, it is possible to use, for example, a rotary table which moves the measurement object relative to the probe. Tactile sensors advantageously enable a relatively high degree of measurement accuracy. An example of a sensor that carries out tactile measurement is the sensor sold by the applicant under the product name “VAST XT” or “VAST XXT”.

For example, sensors using the triangulation principle, such as strip light projectors, are used as optical sensors. A light source, such as a laser diode, is used to generate light on a surface of the measurement object and an image sensor (or camera sensor) is used to capture the light reflected by the surface of the measurement object. This allows conclusions to be drawn about dimensional or geometric properties of the measurement object. Advantageously, optical sensors enable contactless measurement, a relatively high measurement speed and complete surface capture of the measurement object.

An example of a sensor that carries out optical measurement is the optical sensor sold by the applicant under the product name “ViScan”. A further measurement sensor, which uses a laser line projected onto the measurement object to determine coordinate measured values according to the triangulation principle, is offered by the applicant under the name “EagleEye II” for quality assurance in the manufacture of motor vehicle bodies.

An example of measurement software that can be used to measure workpieces with a coordinate measuring machine is the CALIGO measurement software with MultiX technology, which can be combined with the EagleEye II sensor, for example, sold by the applicant.

In order to position the measurement object relative to the measurement head, electrically actuatable positioning devices are usually used in coordinate measuring machines and move the measurement sensor and the measurement object holder relative to each other. Depending on the design of the coordinate measuring machine, the measurement sensor and/or the measurement object holder, for example a measurement table, is/are actively moved. The movement is usually performed along three movement axes that are oriented perpendicular to each other. In certain types, both the measurement sensor and the measurement object holder or the measurement table are moved. In the so-called cantilever design, the measurement table is usually moved along one movement axis and the measurement sensor is moved along two perpendicular movement axes. In coordinate measuring machines of cross-table design, the measurement table can be moved along two movement axes which are oriented orthogonally to each other, whereas the measurement sensor can usually be moved only along one movement axis. In bridge, gantry and column designs, the measurement sensor can usually be moved along three movement axes which are oriented orthogonally to each other. The workpiece holder is often at a fixed position in space.

The control of the positioning device for an automated measurement of the measurement object along a plurality of measurement points can be carried out based on predefined coordinates of the measurement points and a respective target measurement direction in which the measurement sensor is intended to measure.

Exemplary control of the positioning devices of a coordinate measuring machine is known from DE 10 2019 110 508 A1 which has already been mentioned.

With such control of the positioning devices of a coordinate measuring machine, it is often problematic that, when measuring a workpiece, relatively many and/or large axis changes are sometimes necessary to move the measurement sensor from a measurement position to a subsequent measurement position using the movement axes or to orient the measurement sensor in accordance with a measurement direction from measurement point to measurement point. Due to the kinematic properties/limitations of the individual sensor axes, many angle changes of the sensor axes are sometimes necessary in order to move from a predefined measurement orientation to the next measurement orientation. For example, even a relatively small change in the target measurement direction can result in a relatively large change in the axis of rotation. Since moving the measurement sensor along the movement axes requires time, such large axis changes often have a negative, i.e. lengthening, effect on the total time required to measure the measurement object.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It is an object to provide a method for controlling a measurement system for determining dimensional and/or geometric properties, software for carrying out the method and a measurement system for determining dimensional and/or geometric properties, which make it possible to efficiently control the movement of the measurement sensor, specifically in particular for automated measurement of the measurement object.

According to a first aspect, a method is presented for controlling a measurement system for determining dimensional and/or geometric properties of a measurement object, wherein the measurement system has a measurement object holder and a measurement sensor, wherein the measurement sensor defines a reference point for measuring the measurement object and can be moved within a measurement volume relative to the measurement object holder along a plurality of movement axes for measuring a plurality of measurement points of the measurement object, and the method has the following steps of: (i) determining a plurality of permissible measurement directions of the measurement sensor for each of the plurality of measurement points based on a target measurement direction for the respective measurement point, wherein the plurality of permissible measurement directions comply with a measurement direction tolerance in relation to the target measurement direction, and/or determining a plurality of permissible measurement positions of the measurement sensor for each of the plurality of measurement points based on a reference point target position for the reference point for the respective measurement point, wherein the reference point complies with a position tolerance in relation to the reference point target position in the plurality of permissible measurement positions of the measurement sensor, (ii) determining a plurality of permissible axis positions of at least one movement axis of the plurality of movement axes for each of the plurality of measurement points based on the permissible measurement directions and/or the permissible measurement positions for the respective measurement point, and (iii) determining an optimal axis position of the at least one movement axis for each of the plurality of measurement points from the plurality of permissible axis positions previously determined for the respective measurement point in order to optimize the movement of the measurement sensor in the measurement volume.

The presented method is based on the idea of using a measurement range of the measurement sensor adequately suitable for measuring. According to the presented method, it is advantageously not necessary to orient the measurement sensor for each measurement point exactly according to the target measurement direction and/or the reference point target position. Instead, the optimal axis position of the at least one movement axis is determined while complying with a measurement direction tolerance and/or a position tolerance. Thus, the movement of the measurement sensor can be improved without significantly impacting the measurement accuracy and at the same time performing a measurement task with the required measurement accuracy.

According to the presented method, the plurality of permissible measurement directions and/or the plurality of permissible measurement positions for the measurement sensor are first determined for each of the plurality of measurement points. In the following step, which is also referred to as direct kinematics, the plurality of permissible axis positions of the at least one movement axis are determined for each of the plurality of measurement points based on the previously determined plurality of permissible measurement directions and/or the previously determined plurality of permissible measurement positions. In the subsequent step, an optimal axis position of the at least one movement axis is selected from the previously determined plurality of permissible axis positions for each of the plurality of measurement points.

Which of the plurality of permissible axis positions is the optimal axis position may depend on the respectively permissible axis positions of the at least one movement axis for the other ones of the plurality of measurement points. In particular, the optimal axis position can depend on a sequence in which the plurality of measurement points are arranged. The axis position of the at least one movement axis can be optimized independently of the other ones of the plurality of movement axes.

Thus, the dynamic range of a measurement sensor can be optimally used by means of the presented method, and the measurement speed can be improved thereby without the measurement accuracy suffering significantly.

The term “plurality” (e.g. of measurement points, movement axes) is used herein to mean a number of exactly two or more.

The measurement system is preferably a coordinate measuring machine and/or a roughness measuring device.

The measurement sensor defines a reference point for measuring the measurement object. For an exact measurement, the measurement sensor is moved such that the reference point comes to lie in the respective measurement point of the measurement object, the reference point target position. The reference point is a point which is preferably fixed with respect to a body-fixed coordinate system of the measurement sensor. Due to a fixed geometric relationship between the reference point and the measurement sensor, the measurement position of the measurement sensor is thus determined by the position of the reference point and vice versa. For example, the reference point lies on an axis of the measurement sensor corresponding, for example, to the measurement direction of the measurement sensor. The reference point can be arranged within the measurement sensor (e.g. a tactile measurement sensor) or outside the measurement sensor (e.g. an optical measurement sensor).

In the case of optical sensors, the reference point can be a tool center point (TCP). In the case of an optical sensor having an image sensor element and a laser element as a light source, the tool center point may be, for example, in the focus of the laser element and in the focus of the image sensor element. If the laser element projects a line of light onto the surface of the measurement object (such as in a strip light projector), the tool center point can be located in the middle of the projected laser line. The reference point for tactile sensors may be arranged, for example, at the end of the probe pin that makes contact with the surface of the measurement object (e.g. a sphere center point of a probe sphere).

The plurality of measurement points can define a measurement path with a defined sequence of the plurality of measurement points, along which the reference point of the measurement sensor is to be moved.

Each of the plurality of measurement points is characterized by the respective target measurement direction and/or the respective reference point target position. The target measurement direction and/or the reference point target position can be predefined by a user, for example, or determined (by the measurement system), in particular received.

The target measurement direction is a direction in which the measurement sensor is intended to measure. In the case of an optical measurement sensor having an image sensor element and a laser element, the target measurement direction corresponds, for example, to a laser beam axis that runs through the laser element and the respective measurement point. Alternatively, the measurement direction can correspond to an axis that runs through the image sensor element and the respective measurement point. In the case of a measurement sensor that carries out tactile measurement, the target measurement direction can correspond to an axis of the probe element.

The measurement direction tolerance and the position tolerance are used to mean tolerances that refer to the appropriate measurement range of the measurement sensor, which is also referred to in this case as the “dynamic range” of the measurement sensor. It goes without saying that the tolerances are not used to mean any inaccuracies within the scope of technically given positioning inaccuracies of the measurement sensor.

The measurement direction tolerance can be given, for example, by a value range for an angle or a function that defines the value range, wherein the value range specifies the angle at which the permissible measurement direction may be oriented relative to the target measurement direction. It goes without saying that the plurality of permissible measurement orientations include the target measurement direction of the respective measurement point.

The position tolerance may be given by a value range or a function that defines the value range, wherein the value range specifies the value by which the measurement position of the measurement sensor or the reference point of the measurement sensor may deviate from the reference point target position in one or more directions. The maximum permissible deviation may vary depending on the direction. In general, the position tolerance can define a regular or irregular three-dimensional shape that represents a subset of the measurement volume for each reference point, the subset comprising the reference point target position.

In the case of sensors that carry out tactile measurement, the position tolerance can be adjusted in order to avoid collisions between the measurement sensor or the probe element and the measurement object. The position tolerance can be, for example, a two-dimensional shape. For example, the position tolerance may be in a plane, in which case the normal of the plane is orthogonal to the surface of the measurement object at the reference point. Alternatively, the position tolerance can be zero (no measurement position tolerance), for example.

The permissible measurement positions can be determined, in particular in the case of optical sensors, taking into account the (global) geometry of the measurement object in order to avoid collisions between the measurement sensor and the measurement object (e.g. in the case of relatively complex geometries).

It goes without saying that the value of the measurement direction tolerance and/or the value of the position tolerance may vary from measurement point to measurement point. For example, the measurement direction tolerance and/or the position tolerance can be specified in sections on the measurement object or in sections along the measurement path (for example by a user).

The corresponding axis positions of the plurality of movement axes can be calculated from the measurement direction and the measurement position of the measurement sensor using “direct kinematics”. Conversely, predefined axis positions of the plurality of movement axes define the measurement direction and/or the measurement position of the measurement sensor. The axis position can be defined by axis values, such as rotational angle values for an axis of rotation and linear axis values for a linear axis.

The plurality of movement axes may have at least one axis of rotation and/or at least one linear axis.

In a refinement, for the respective measurement point, the target measurement direction and the plurality of permissible measurement directions run through a common point.

The common point can be the respective measurement point of the measurement object or the reference point of the measurement sensor.

This provides the advantage that in each of the permissible measurement directions, the reference point of the measurement sensor may be at the measurement point or in the reference point target position. This can have a positive effect on the measurement accuracy.

The measurement direction tolerance can define a two-dimensional or three-dimensional envelope that envelops and delimits the permissible measurement directions. For example, the envelope has the shape of a pyramid or any free shape in space.

In a further refinement, for the respective measurement point, the permissible measurement directions are within a defined envelope cone around the target measurement direction.

This provides the advantage that the permissible measurement directions can be evenly distributed or discretized in the envelope cone. Thus, a plurality of equally differently oriented permissible measurement directions can be included in the optimization with a reasonable amount of computational effort. Thus, an adequate “search range” for an optimal measurement direction or an optimal axis position of the at least one movement axis can be covered.

Preferably, the envelope cone has half an opening angle of less than or equal to 80°, less than or equal to 70°, less than or equal to 60°, less than or equal to 50°, less than or equal to 40°, less than or equal to 30°, less than or equal to 20°, less than or equal to 100 or less than or equal to 5°. Half the opening angle of the envelope cone is defined by the angle between one of the surface lines and a symmetry axis of the envelope cone.

The optimal measurement direction is used in this case to denote a measurement direction of the measurement sensor that is predefined by the optimal axis position of the at least one movement axis determined in step (iii), wherein the at least one movement axis is an axis of rotation in particular.

Preferably, the target measurement direction is the symmetry axis of the envelope cone. The permissible measurement directions can then each include, with the target measurement direction, an angle that is less than or equal to the measurement direction tolerance. This provides the advantage that the permissible measurement directions can thus be evenly distributed around the target measurement direction.

In a further refinement, in the plurality of permissible measurement positions of the measurement sensor, the reference point is in a plane with the respective reference point target position.

This has the advantage that a plurality of differently permissible measurement positions can be included in the optimization with a reasonable amount of computational effort (corresponding to an “adequate search range”).

Preferably, the permissible measurement positions are evenly distributed in the plane according to a uniform discretization.

The position tolerance can define a shape, such as a circular disk, a line, a rectangle, or an ellipse, which lies in the plane around the reference point target position, and specifies permissible positions for the reference point and thus permissible measurement positions for the measurement sensor.

Preferably, the target measurement direction, the measurement direction of the measurement sensor or the optimal measurement direction is in the plane.

For example, a normal of the plane can correspond to a tangent on a spline that runs through the plurality of measurement points and defines the measurement path. This means in particular the tangent at the respective measurement point (i.e. the normal of the plane points in a direction along the measurement path).

Alternatively, the normal of the plane may include an angle to the tangent on the spline, the angle corresponding to an intersection angle between the target measurement direction and the optimal measurement direction of the measurement sensor. Alternatively, the angle corresponds to the intersection angle between the target measurement direction and the measurement direction of the measurement sensor.

In a further refinement, in step (ii), for each of the plurality of measurement points, permissible axis positions are additionally determined for at least another one of the plurality of movement axes and the determination of the optimal axis position of the at least one movement axis that is carried out in step (iii) depends on the permissible axis positions of the at least one other movement axis that are determined in step (ii).

This has the advantage that the movement of the measurement sensor is optimized taking into account the kinematics of the at least one other one of the plurality of movement axes or taking into account the kinematic relationship between the plurality of movement axes.

In a further refinement, the plurality of movement axes include a plurality of axes of rotation, wherein, in step (i), the plurality of permissible measurement directions of the measurement sensor are determined for each of the plurality of measurement points based on the target measurement direction for the respective measurement point, in step (ii), the plurality of permissible axis positions of at least one axis of rotation are determined for each of the plurality of measurement points based on the permissible measurement directions and, in step (iii), the optimal axis position of the at least one axis of rotation is determined for each of the plurality of measurement points from the plurality of permissible axis positions of the at least one axis of rotation that were previously determined for the respective measurement point.

This configuration therefore takes into account in particular the use of the orientation tolerance of the measurement sensor. This is particularly advantageous if the rotational movement of the measurement sensor along the plurality of axes of rotation significantly influences a measurement sequence when measuring the measurement object.

The optimal axis position is preferably determined in each case for each of the plurality of axes of rotation (in dependence on or independently of each other).

In a further refinement, the plurality of movement axes include a plurality of linear axes, wherein, in step (i), the plurality of permissible measurement positions of the measurement sensor are determined for each of the plurality of measurement points based on a reference point target position for the respective measurement point, in step (ii), the plurality of permissible axis positions of at least one linear axis are determined for each of the plurality of measurement points based on the permissible measurement positions for the respective measurement point and, in step (iii), the optimal axis position of the at least one linear axis is determined for each of the plurality of measurement points from the plurality of permissible axis positions of the at least one linear axis that were previously determined for the respective measurement point.

This configuration therefore takes into account in particular the use of the position tolerance of the measurement sensor. This allows the movement of the measurement sensor along the at least one linear axis to be optimized.

The optimal axis position is preferably determined in each case for each of the plurality of linear axes (in dependence on or independently of each other).

In a further refinement, the plurality of movement axes include a plurality of linear axes and a plurality of axes of rotation, wherein, in step (i), the plurality of permissible measurement directions of the measurement sensor are determined for each of the plurality of measurement points based on the target measurement direction for the respective measurement point, in step (ii), the plurality of permissible axis positions of at least one axis of rotation are determined for each of the plurality of measurement points based on the permissible measurement directions, in step (iii), the optimal axis position of the at least one axis of rotation is determined for each of the plurality of measurement points from the plurality of permissible axis positions of the at least one axis of rotation that were previously determined for the respective measurement point, in a step (iv), the plurality of permissible measurement positions of the measurement sensor are determined for each of the plurality of measurement points based on a reference point target position for the respective measurement point, in a step (v), the plurality of permissible axis positions of at least one linear axis are determined for each of the plurality of measurement points based on the permissible measurement positions for the respective measurement point and, in a step (vi), the optimal axis position of the at least one linear axis is determined for each of the plurality of measurement points from the plurality of permissible axis positions of the at least one linear axis that were previously determined for the respective measurement point.

This configuration therefore takes into account both the use of the orientation tolerance and the use of the position tolerance of the measurement sensor. This allows the movement of the measurement sensor to be optimized both along the at least one axis of rotation and along the at least one linear axis.

The optimal axis position is preferably determined in each case for each of the plurality of axes of rotation and for each of the plurality of linear axes (in dependence on or independently of each other).

Further preferably, the above-mentioned steps (iv), (v) and (vi) are carried out while maintaining the optimal axis position of the at least one axis of rotation that was previously determined in step (iii).

Thus, first the optimal axis position of the at least one axis of rotation, which specifies the optimal measurement direction of the measurement sensor, is determined and then the optimal axis position of the at least one linear axis, which determines an optimal measurement position of the measurement sensor, is determined. This has the advantage that the measurement position of the measurement sensor can be varied while maintaining the optimal measurement direction, in which case the measurement accuracy is not significantly impaired.

The optimal measurement position is used in this case to denote a measurement position of the measurement sensor that is defined by the optimal axis position of the at least one linear axis determined in step (iii).

In a further refinement, the optimization of the movement of the measurement sensor in step (iii) comprises a time optimization and/or an optimization of changes in the absolute value of the axis position of the at least one movement axis.

In particular, it is possible to optimize the movement of the measurement sensor along the movement axes which are decisive for the measurement sequence or the time duration of the measurement. For example, this makes it possible to make the movement along the plurality of movement axes less jerky. “Shifts” of the movement axes can also be avoided. A shift is used in the present case to denote a relatively large change in a movement axis that is accompanied by only a relatively small change in the measurement position of the measurement sensor or the measurement direction of the measurement sensor. The time optimization can be carried out taking into account limit values for permissible speeds and/or accelerations of the measurement sensor.

It goes without saying that the type of optimization, i.e. the optimization aimed at time and/or a change in the absolute value of the axis position, can change in sections along the measurement path (for example as a result of a specification of the user of the measurement system).

In a further refinement, the change in the absolute value of the axis position of the at least one movement axis is optimized under a condition that the at least one movement axis is moved to the minimum possible extent from one of the measurement points to a subsequent one of the plurality of measurement points, or that a total movement of the at least one movement axis along the plurality of measurement points is minimally possible.

This provides the advantage that the measurement object can be measured in such a way that the at least one movement axis is moved as little as possible and thus the measurement sensor is also moved as little as possible.

Preferably, the change in the absolute value of one or more axes of rotation is minimized.

In a further refinement, the time optimization is carried out under a condition that the time required for moving the measurement sensor along the at least one movement axis from one of the measurement points to a subsequent one of the plurality of measurement points is as short as possible, or that a total duration required for moving the measurement sensor along the at least one movement axis and along the plurality of measurement points is as short as possible.

This has the advantage that the measurement object can be measured as quickly as possible.

In a further refinement, the method has the steps of: determining control data based on the optimal axis position of the at least one movement axis for each of the plurality of measurement points and moving the measurement sensor based on the control data.

This has the advantage that the optimal axis position of the at least one movement axis for each of the plurality of measurement points can be quickly and easily converted into control data for the movement axes of the measurement system. In addition, the measurement sensor can be advantageously moved according to the optimal axis position of the at least one movement axis previously determined in step (iii).

According to a second aspect, a measurement system for determining dimensional and/or geometric properties of a measurement object is presented, having:
a measurement object holder,
a measurement sensor which defines a reference point for measuring the measurement object and can be moved within a measurement volume relative to the measurement object holder along a plurality of movement axes for measuring a plurality of measurement points of the measurement object,
a controller which is configured to move the measurement sensor along the plurality of movement axes on the basis of control data, and
a processor which is configured to determine the control data for the controller, wherein, in order to determine control data, the processor is configured:
   (i) to determine a plurality of permissible measurement directions of the measurement sensor for each of the plurality of measurement points based on a target measurement direction for the respective measurement point, wherein the plurality of permissible measurement directions comply with a measurement direction tolerance in relation to the target measurement direction for the respective measurement point, and/or to determine a plurality of permissible measurement positions of the measurement sensor for each of the plurality of measurement points based on a reference point target position for the reference point for the respective measurement point, wherein the reference point complies with a position tolerance in relation to the reference point target position in the plurality of permissible measurement positions of the measurement sensor,
   (ii) to determine a plurality of permissible axis positions of at least one movement axis of the plurality of movement axes for each of the plurality of measurement points based on the permissible measurement directions and/or permissible measurement positions for the respective measurement point, and
   (iii) to determine an optimal axis position of the at least one movement axis for each of the plurality of measurement points from the plurality of permissible axis positions previously determined for the respective measurement point in order to optimize the movement of the measurement sensor in the measurement volume.

It is advantageously not necessary to orient the measurement sensor for each measurement point exactly according to the target measurement direction and/or the reference point target position. Instead, the optimal axis position of the at least one movement axis is determined while complying with the measurement direction tolerance and/or the position tolerance. Thus, the movement of the measurement sensor can be improved without significantly impacting the measurement accuracy and at the same time performing a measurement task with the required measurement accuracy.

In a refinement, the measurement system has:
an interface for receiving parameters that define, for each of the plurality of measurement points, the target measurement direction, the reference point target position, the measurement direction tolerance, and/or the measurement position tolerance, and/or define limit values for permissible speeds and/or accelerations of the measurement sensor along the plurality of movement axes, and
a memory in which the parameters can be stored.

This provides the advantage that the parameters can be stored in the memory and the processor can use the data when determining the control data.

For example, the interface is a user interface that can be used to input the parameters. Alternatively, the interface can receive the parameters from another (technical) apparatus.

The above-mentioned configurations of the method also equivalently apply to the measurement system:

In particular, according to another configuration, for the respective measurement point, the target measurement direction and the plurality of permissible measurement directions run through a common point.

In a further refinement, for the respective measurement point, the permissible measurement directions are within a defined envelope cone around the target measurement direction.

In a further refinement, in the plurality of permissible measurement positions of the measurement sensor, the reference point is in a plane with the respective reference point target position.

In a further refinement, the processor is configured, in (ii), for each of the plurality of measurement points, to additionally determine permissible axis positions for at least another one of the plurality of movement axes, wherein the determination of the optimal axis position of the at least one movement axis that is carried out in (iii) depends on the permissible axis positions of the at least one other movement axis that are determined in (ii).

In a further refinement, the plurality of movement axes include a plurality of axes of rotation, and the processor is configured, in (i), to determine the plurality of permissible measurement directions of the measurement sensor for each of the plurality of measurement points based on the target measurement direction for the respective measurement point, in (ii), to determine the plurality of permissible axis positions of at least one axis of rotation for each of the plurality of measurement points based on the permissible measurement directions and, in (iii), to determine the optimal axis position of the at least one axis of rotation for each of the plurality of measurement points from the plurality of permissible axis positions of the at least one axis of rotation that were previously determined for the respective measurement point.

In a further refinement, the plurality of movement axes include a plurality of linear axes, and the processor is configured, in (i), to determine the plurality of permissible measurement positions of the measurement sensor for each of the plurality of measurement points based on a reference point target position for the respective measurement point, in (ii), to determine the plurality of permissible axis positions of at least one linear axis for each of the plurality of measurement points based on the permissible measurement positions for the respective measurement point and, in (iii), to determine the optimal axis position of the at least one linear axis for each of the plurality of measurement points from the plurality of permissible axis positions of the at least one linear axis that were previously determined for the respective measurement point.

In a further refinement, the plurality of movement axes include a plurality of linear axes and a plurality of axes of rotation, and the processor is configured, in (i), to determine the plurality of permissible measurement directions of the measurement sensor for each of the plurality of measurement points based on the target measurement direction for the respective measurement point, in (ii), to determine the plurality of permissible axis positions of at least one axis of rotation for each of the plurality of measurement points based on the permissible measurement directions, in (iii), to determine the optimal axis position of the at least one axis of rotation for each of the plurality of measurement points from the plurality of permissible axis positions of the at least one axis of rotation that were previously determined for the respective measurement point, in (iv), to determine the plurality of permissible measurement positions of the measurement sensor for each of the plurality of measurement points based on a reference point target position for the respective measurement point, in (v), to determine the plurality of permissible axis positions of at least one linear axis for each of the plurality of measurement points based on the permissible measurement positions for the respective measurement point and, in (vi), to determine the optimal axis position of the at least one linear axis for each of the plurality of measurement points from the plurality of permissible axis positions of the at least one linear axis that were previously determined for the respective measurement point.

In a further refinement, the optimization of the movement of the measurement sensor comprises a time optimization and/or an optimization of changes in the absolute value of the axis position of the at least one movement axis.

In a further refinement, the change in the absolute value of the axis position of the at least one movement axis is optimized under a condition that the at least one movement axis is moved to the minimum possible extent from one of the measurement points to a subsequent one of the plurality of measurement points, or that a total movement of the at least one movement axis along the plurality of measurement points is minimally possible.

In a further refinement, the time optimization is carried out under a condition that the time required for moving the measurement sensor along the at least one movement axis from one of the measurement points to a subsequent one of the plurality of measurement points is as short as possible, or that a total duration required for moving the measurement sensor along the at least one movement axis along the plurality of measurement points is as short as possible.

As already mentioned at the outset, a further aspect of the disclosure relates to a computer program product having program code which is configured to carry out the method when the program code is executed on the processor of the measurement system.

It goes without saying that the features mentioned above and the features also explained below can be used not only in the respectively specified combination but also in other combinations or on their own without departing from the spirit and scope of the present disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a simplified schematic illustration of a measurement system according to an embodiment;

FIG. 2 shows a simplified schematic illustration of axes of rotation;

FIG. 3 shows a schematic illustration of a measurement sensor;

FIG. 4 shows a schematic illustration of a dynamic range of the measurement sensor;

FIG. 5 shows a schematic illustration of tilting of the measurement sensor;

FIG. 6 shows a schematic illustration of a method according to an embodiment;

FIG. 7 shows a schematic illustration of a measurement direction tolerance;

FIG. 8 shows a schematic illustration of a position tolerance;

FIG. 9 shows a schematic illustration of a selection of the optimal axis position;

FIG. 10 shows a schematic illustration of a plurality of optimal measurement directions;

FIG. 11 shows a schematic illustration of a plurality of optimal measurement positions; and

FIG. 12 shows a schematic illustration of a plurality of optimal measurement positions taking into account the optimal measurement direction.

In the drawings, reference numbers may be reused to identify similar and/or identical elements.

### DETAILED DESCRIPTION

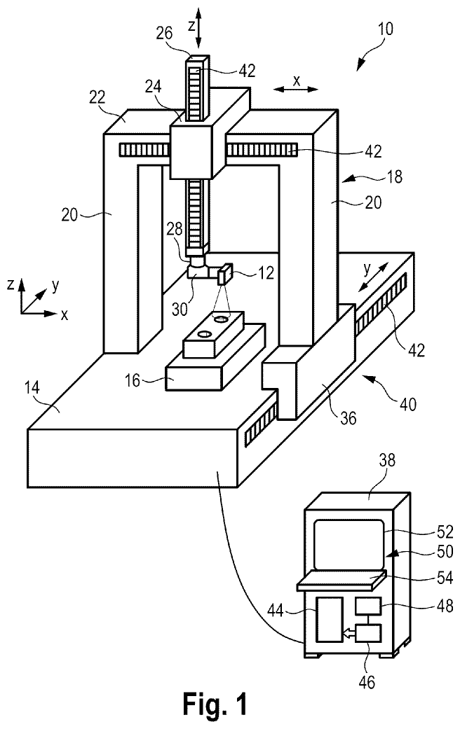

FIGS. 1 to 3 show a simplified illustration of a measurement system according to an embodiment. The measurement system is denoted in its entirety with the reference number 10 and in this example is in the form of a coordinate measuring machine. The coordinate measuring machine 10 is of gantry design. However, it goes without saying that this is only one of various possible designs of a coordinate measuring machine, with the aid of which the basic structure and the function of a coordinate measuring machine are explained below. However, this disclosure is by no means limited to the control of a coordinate measuring machine with such a structure, but can also be used to control other measurement systems that are used in dimensional measurement technology.

The coordinate measuring machine 10 has a measurement sensor 12 for measuring a workpiece and a workpiece holder 14, on which the workpiece, a measurement object 16, can be placed.

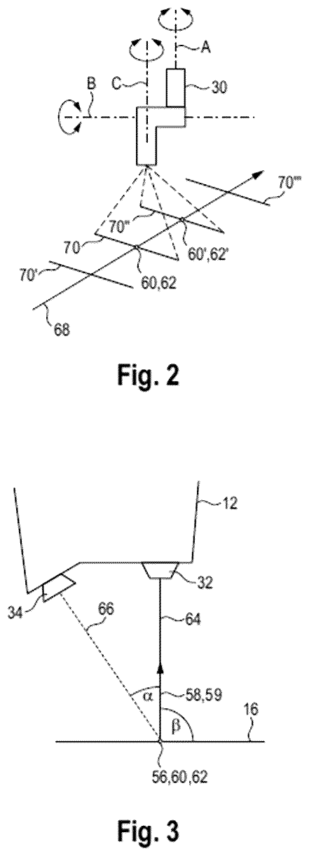

A gantry 18 is arranged in the present case on the workpiece holder 14, which is also referred to as the base. The gantry 18 serves as a movable support structure for the measurement sensor 12 and has two columns 20 and a crossbeam 22 on which a carriage 24 is movably mounted. The carriage 24 carries a sleeve 26, to the lower end of which a change interface 28 is fastened. A multi-axis swivel joint 30 is arranged at the change interface 28 and carries the measurement sensor 12. The multi-axis swivel joint 30 has three axes of rotation A, B and C (FIG. 2).

The measurement sensor 12 is configured as an optical measurement sensor with a laser element 32 and an image sensor element 34 (FIG. 3).

The coordinate measuring machine 10 further has a positioning device 36 for positioning the measurement sensor 12 and the measurement object holder 14 relative to each other. This positioning device 36 includes a control unit 38, a plurality of drives used to move the measurement sensor 12 and the measurement object holder 14 relative to each other, and a plurality of measurement scales 42. The control unit 38 has a controller 44, a processor 46, a memory 48 and an operating terminal 50, which has for example a monitor 52 and a keyboard 54.

In the present example, in which the measurement system 10, the coordinate measuring machine, is of gantry design, said drives move the measurement sensor 12 with respect to the measurement object holder 14, which is fixed. The measurement sensor 12 can be moved along three coordinate axes oriented orthogonally to each other. These coordinate axes are referred to in the present case as linear axes X, Y, Z. One of these drives is provided with the reference number 40 by way of example. This drive 40 is configured to move the gantry 18 along the y-axis with respect to the measurement object holder 14. The carriage 24 can be moved on the crossbeam 22 along the linear axis X by means of a further drive (not denoted separately here). The sleeve 26 can be moved along the linear axis Z relative to the carriage 24.

The measurement scales 42 are designed, in conjunction with corresponding reading heads (not illustrated here), to determine the respective current position of the gantry 18 relative to the workpiece support 14, to determine the relative position of the carriage 24 relative to the crossbeam 22 and to determine the position of the sleeve 26 relative to the carriage 24. Encoders are arranged in the multi-axis swivel joint 30 and can be used to determine in a similar manner a respective current rotational and swivel position of the measurement sensor 12 relative to the sleeve 26. Said position values are supplied to the control unit 38 which then determines the spatial coordinates of a measurement point on the measurement object 16 based on the scale and encoder values.

Furthermore, the control unit 38 is configured to control the drives to move the gantry 18, the carriage 24 and the sleeve 26 as well as the drives of the multi-axis swivel joint 30 in order to bring the measurement sensor 12 into a defined position relative to the measurement object 16.

The control unit 38 is generally used not only to control the positioning device 36 and thus to control the individual drives, but also to evaluate the data obtained by the measurement sensor 12 and to determine the spatial coordinates of the measurement object 16 based on the evaluated measurement data.

As schematically illustrated in FIG. 2, the measurement sensor 12 can be rotated or pivoted relative to the measurement object 16 or the measurement object holder 14 by means of the three axes of rotation A, B and C. The axes of rotation A and C run parallel to each other and are offset laterally in the direction of the axis of rotation B. The axis of rotation B is orthogonal to the axes of rotation A and B and is arranged between the axis of rotation A and the axis of rotation B.

An orientation of the measurement object 16 relative to the measurement object holder 14 can be determined by means of defined reference points of the measurement object 16.

FIG. 3 shows a schematic illustration of the measurement sensor 12 which is configured here as an optical triangulation laser sensor. The laser element 32 projects light onto the surface of the measurement object 16. For example, the laser element 32 is a laser diode. The image sensor element 34 captures the light reflected by the surface of the measurement object 16. Based on the properties of the captured light and on trigonometric relationships, the distance between the surface of the measurement object 16 illuminated by the light and the measurement sensor 12 can be calculated. Thus, conclusions can be drawn about the dimensional and/or geometric properties of the measurement object 16.

In a known procedure, the measurement takes place at a measurement point 56 based on a target measurement direction 58 and a reference point target position 60, which are respectively specified for each of a plurality of measurement points 56. The target measurement direction 58 specifies a measurement direction 59 of the measurement sensor 12. The reference point target position 60 defines coordinates of the measurement point 56 in the Cartesian coordinate system x, y, z.

For example, the target measurement direction 58 and the reference point target position 60 can be specified by the user via the operating terminal 50. Alternatively, the target measurement direction 58 and the reference point target position 60 can be specified by the controller 44. For example, the target measurement direction 58 and the reference point target position 60 can be derived from a CAD model of the measurement object 16.

The measurement sensor 12 defines a reference point 62, the so-called tool center point (TCP), which comes to lie in the specified reference point target position 60 when the measurement sensor 12 is oriented exactly. For the measurement along the plurality of measurement points 56, the reference point 62 is moved on the surface of the measurement object 16 according to a plurality of reference point target positions 60.

When the measurement sensor 12 is oriented exactly, the measurement direction 59 corresponds to the target measurement direction. The target measurement direction 58 defines the angle at which a defined reference axis of the measurement sensor 12 is intended to be oriented with respect to the surface of the measurement object 16. In the present case, a laser element axis 64 defines the measurement direction 59 of the measurement sensor 12. The laser element axis 64 includes, with the surface of the measurement object 16, an angle β which is specified via the target measurement direction 58 for the measurement.

Alternatively, the target measurement direction 58 can also be specified via the image sensor element axis 66 which includes a fixed angle α with the laser element axis 64. In this case, the image sensor element axis 66 defines the measurement direction 59 of the measurement sensor 12.

The angle β can be 90°, as illustrated in FIG. 3. In the case of highly reflective surfaces of the measurement object 16, it may be advantageous to specify the angle β as deviating from 90°, for example with β=90°±10.15°.

In this case, the “tilting” of the target measurement direction 58 is carried out relative to a measurement path 68 (also referred to in the present case as a “scan path” or “movement path”) which is specified by a defined sequence of the plurality of measurement points 56. The target measurement direction 58 includes the angle β with a direction along the measurement path 68. Depending on the value of the angle β, the measurement sensor 12 thus “leads” the respective measurement point 56 along the measurement path 68 (indicated with the reference point target position 60 and the reference point 62) or “lags” it (indicated with the reference point target position 60′ and the reference point 62′) (FIG. 2).

The measurement principles of such optical measurement sensors 12 are already known in principle in the prior art.

As indicated in FIG. 2, the measurement sensor 12 can, for example, project a line of light 70 onto the surface of the measurement object 16, wherein the reference point 62 is located in a center of the line of light 70. The line of light 70 is preferably oriented orthogonally to the direction of the measurement path 68. Four successive positions of the line of light 70 along the measurement path 68 are indicated with the reference numbers 70′, 70, 70″, 70′″. The curvature of the (light) strips can be used to draw conclusions about the properties of the surface of the measurement object 16.

Alternatively, the measurement sensor 12 can project other light patterns onto the surface of the measurement object 16, such as a light pattern with a plurality of parallel strips. The underlying measurement principle is, for example, the known measurement principle of strip projection, which is also referred to as strip light scanning or strip light topometry.

Irrespective of the type of measurement principle of the measurement sensor 12, the disclosure is based on the knowledge that an exact orientation of the measurement sensor 12 relative to the respective measurement point according to the target measurement direction 58 and the reference point target position 60 can be accompanied by relatively large changes in the axis positions of the linear axes X, Y, Z and/or the axes of rotation A, B, C. However, the changes in the axis positions of the linear axes X, Y, Z and/or of the axes of rotation A, B, C are usually time-consuming, which has a negative effect on a measurement time required for measuring along the plurality of measurement points 56 along the measurement path 68.

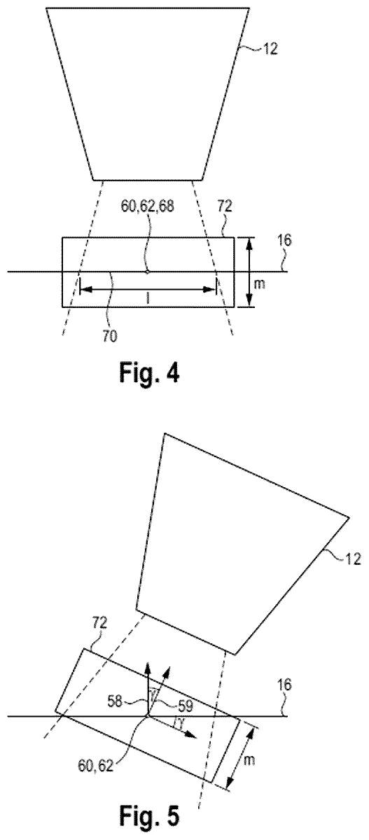

FIG. 4 shows a view in the direction of the measurement path 68 (FIG. 2) and a schematic illustration of a tolerance range 72 of the measurement sensor 12, which is also referred to in the present case as the dynamic range. A sufficiently appropriate measurement accuracy can be achieved in the tolerance range 72. The tolerance range 72 is used to optimize the movement of the measurement sensor 12 without significantly impacting the measurement accuracy.

When using the tolerance range 72, the reference point 62 can be shifted in the tolerance range 72 relative to the reference point target position 60 (not illustrated in FIG. 4). In this case, the use of a width b of the tolerance range 72 can be limited by a length l of the line of light 70.

In addition, the measurement direction 59 of the measurement sensor 12 can be tilted by a tolerance angle γ relative to the target measurement direction 58 (FIG. 5). The tolerance range 72 is “concomitantly tilted”. Alternatively, the tolerance range 72 is not concomitantly tilted.

FIG. 5 shows a measurement sensor 12 tilted clockwise by the tolerance angle γ (relative to the orientation of the measurement sensor 12 shown in FIG. 4). It goes without saying that the measurement sensor 12 can likewise be tilted anticlockwise.

The tolerance angle may be dependent on various factors such as properties of e.g. the surface of the measurement object 16 (among others reflection properties), the measurement sensor 12, the measurement task, a required measurement accuracy and/or possible collisions with the measurement object 16 and/or clamping apparatuses of the measurement system 10.

An optimal angle range can be determined, for example, by evaluating the scatter in a measurement series with different angular positions on the surface of the measurement object 16.

For example, the tolerance angle γ parallel to the line of light 70 with the measurement range m and a length l of the line of light 70 can be determined using the relationship γ=tan−1 (m/l). For a measurement range of m=60 mm and a length of l=80 mm of the line of light 70, an angle γ of approx. 37° is thus obtained by way of example.

A tolerance angle perpendicular to the line of light 70 may correspond to the tolerance angle γ parallel to the line of light 70. The structure of an optical line triangulation measurement sensor 12 in principle enables a maximum orientation tolerance of <1800−α. In certain applications, an orientation deviation in subranges of ±180° may be possible, in which case direction specifications are no longer observed for these ranges.

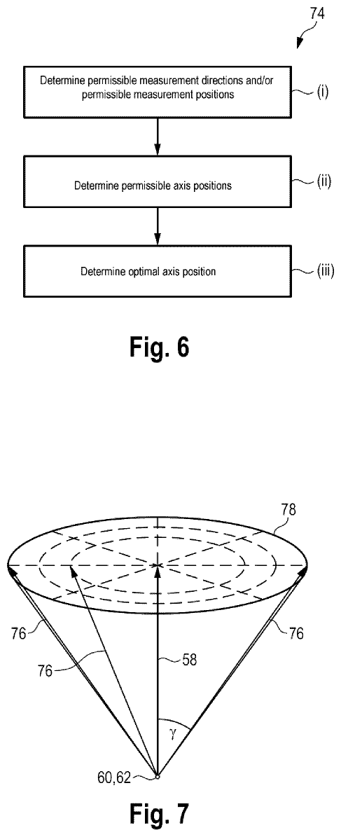

FIGS. 6 to 9 show a schematic illustration of a first exemplary embodiment of a method 74 for controlling the measurement system 10. In a first step (i), a plurality of permissible measurement directions 76 of the measurement sensor 12 are determined for each of the plurality of measurement points 56 based on a target measurement direction 58 for the respective measurement point 56, wherein the plurality of permissible measurement directions 76 comply with a measurement direction tolerance in relation to the target measurement direction 58, and/or a plurality of permissible measurement positions 84 of the measurement sensor 12 are determined for each of the plurality of measurement points 56 based on a reference point target position 60 for the respective measurement point 56, wherein the reference point 62 complies with a position tolerance in relation to the reference point target position 60.

In a second step (ii), a plurality of permissible axis positions 86 of at least one movement axis X, Y, Z, A, B, C of the plurality of movement axes X, Y, Z, A, B, C are determined for each of the plurality of measurement points 56 based on the permissible measurement directions 76 and/or the permissible measurement positions 84 for the respective measurement point 56.

In a third step (iii), an optimal axis position 94 of the at least one movement axis X, Y, Z, A, B or C is determined for each of the plurality of measurement points 56 from the plurality of permissible axis positions 86 previously determined for the respective measurement point 56 in order to optimize the movement of the measurement sensor 12 in the measurement volume.

Based on the optimal axis position 94 of the at least one movement axis X, Y, Z, A, B, C, the processor 46 determines control data that are used by the controller 44 to move the measurement sensor 12 along the movement axes X, Y, Z, A, B, C.

The axis position of the at least one movement axis X, Y, Z, A, B, C is optimized taking into account limit values for permissible speeds and/or accelerations of the measurement sensor 12 along the respective movement axis X, Y, Z, A, B, C. The limit values for the permissible speeds and/or accelerations are stored in the memory 48 (FIG. 1).

The memory 48 also stores the target measurement direction 58, the reference point target position 60, the measurement direction tolerance and the measurement position tolerance for each of the plurality of measurement points 56.

FIG. 7 shows a schematic illustration of the plurality of permissible measurement directions, some of which are provided with the reference sign 76 by way of example. The permissible measurement directions 76 run with the target measurement direction 58 through a common point, which corresponds here in the present case to the reference point 62 or the reference point target position 60. The permissible measurement directions 76 are within an envelope cone 78 which specifies a maximum intersection angle between the target measurement direction 60 and one of the plurality of permissible measurement directions 76 which corresponds to the tolerance angle γ.

By way of example, the tolerance angle, which is defined here by the envelope cone 78 and corresponds here to half the opening angle of the envelope cone 78, is approx. 35°.

The permissible measurement directions 76 can likewise be determined for optical as well as tactile measurement sensors 12.

The permissible measurement directions 76 are discretized within the envelope cone 78, which is indicated with a grid on the envelope cone 78. The finer the resolution, the more accurate, but also the more computationally intensive the optimization of the axis position of the at least one movement axis X, Y, Z, A, B, C. The degree of discretization can be defined as required for the application.

Alternatively, the plurality of permissible measurement directions 76 may be limited by any other envelope shape, such as a pyramid. The shape of the envelope can be defined independently in the direction of and perpendicular to the measurement path 68.

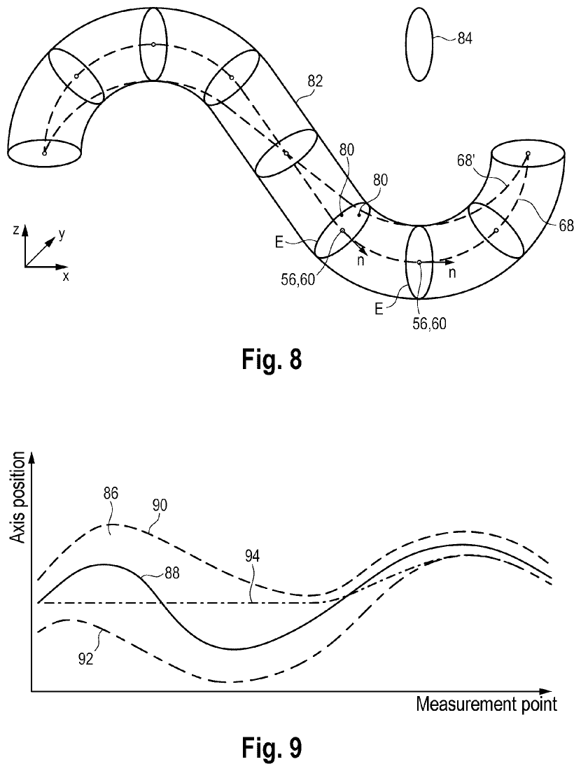

FIG. 8 shows a schematic illustration of the position tolerance along the measurement path 68. The measurement path 68 is specified by a spline that runs through the plurality of measurement points 56 or the corresponding reference point target positions 60. For the respective measurement point 56, permissible positions of the reference point 62 are in a circular plane E around the measurement point 56 or the corresponding target position 60. By way of example, a few permissible positions of the reference point are marked with the reference sign 80. A normal n of the plane E corresponds to a tangent of the spline at the respective measurement point 56 or the respective reference point target position 60. A boundary of the plane E in space defines maximum deviations of the reference point 62 from the reference point target position 60 in the plane E. In the direction of the normal n of the plane E, the position tolerance is essentially zero.

In this example, the plurality of permissible positions 80 of the reference point 62 form a tubular tolerance range 82 along the measurement path 68. The diameter of the plane E at the respective measurement point 56 or the respective reference point target position 60 is, for example, up to one centimeter.

Alternatively, the tolerance range 82 may also have any two-dimensional shape, such as an elliptical, rectangular or square cross section, or may be defined by a straight line or a line.

The plurality of permissible positions 80 of the reference point 62 for the respective measurement point 56 are converted into the plurality of permissible measurement positions of the measurement sensor 12, which are schematically illustrated here for one of the plurality of measurement points 56 and are denoted with the reference sign 84. Due to the fixed geometric relationship between the reference point 62 and the measurement sensor 12, the plurality of permissible measurement positions 84 of the measurement sensor 12 vary with the same position tolerance as the permissible positions 80 of the reference point 62.

Alternatively, the reference point 62 is arranged within the measurement sensor 12 (for example in the case of a tactile measurement sensor), and so the permissible positions 80 of the reference point 62 can correspond to the permissible measurement positions 84 of the measurement sensor 12.

The optimal axis position of one or more linear axes X, Y, Z, is then used to determine an optimal measurement path 68′, along which the position tolerance is complied with for the respective measurement point 56.

FIG. 9 shows a schematic illustration of the selection of the optimal axis position of the at least one movement axis X, Y, Z, A, B, C from the plurality of permissible axis positions of the at least one movement axis X, Y, Z, A, B, C, which are indicated here by way of example with the reference sign 86. The permissible axis positions 86 are around a conventional, non-optimized axis position 88 (corresponding to an exact orientation of the measurement sensor 12 with the target measurement direction 58 and/or the reference point target position 60). The permissible axis positions 86 are limited for each measurement point 56 by a maximum permissible axis position 90 and a minimum permissible axis position 92.

The optimal axis position 94 is determined in such a way that the at least one movement axis X, Y, Z, A, B, C is moved as little as possible without the measurement direction tolerance and/or the position tolerance being exceeded.

Alternatively, it is possible to minimize the time required to move the measurement sensor along one or more movement axes along the measurement path.

In the present case, the optimal axis position is determined by means of a “Euclidean Shortest Path” search algorithm. It goes without saying that another suitable algorithm can be alternatively used to determine the optimal axis position of the at least one movement axis.

The optimal axis position 94 at the respective measurement point 56 is dependent on the plurality of permissible axis positions 86 of the at least one movement axis X, Y, Z, A, B, C for the subsequent or previous measurement points 56, with the result that the axis position is optimized based on the entire measurement path 68.

The axis position can be optimized in dependence on or independently of the other movement axes X, Y, Z, A, B, C. If a plurality of movement axes X, Y, Z, A, B, C, such as the three axes of rotation A, B, C, are optimized at the same time, the permissible axis positions 86 of the axes of rotation A, B, C form, at the respective measurement point 56 and along the measurement path 68, a three-dimensional shape, within which the optimal axis position 94 for each of the axes of rotation A, B, C can be determined.

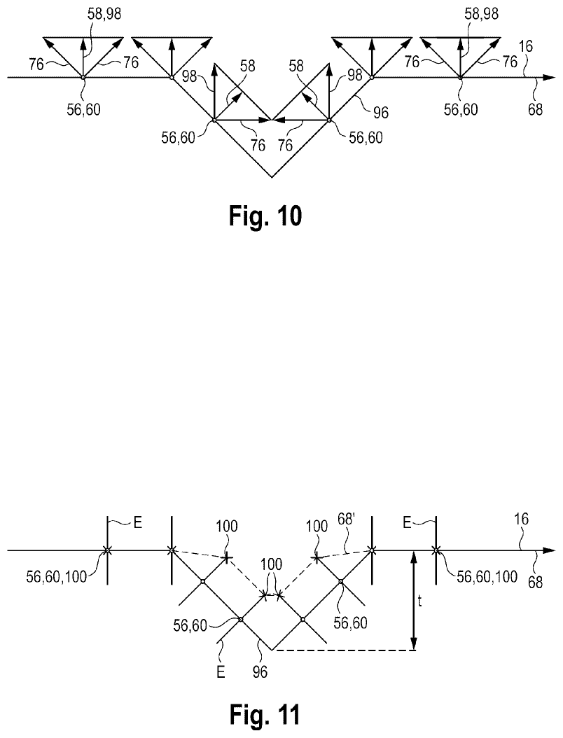

FIG. 10 shows a schematic illustration of the optimization of the measurement direction 59 of the measurement sensor 12 in the case of a recess 96 in the measurement object 16. The proportions are illustrated in an exaggerated form in FIG. 10 for clarification. In FIG. 10, the target measurement direction 58, the plurality of permissible measurement directions 76 and an optimal measurement direction 98 are indicated by way of example at the plurality of measurement points 56.

The optimal measurement direction 98 is determined by the optimal axis position 94 of one or more of the axes of rotation A, B, C and corresponds to the measurement direction 59 of the measurement sensor 12 with an optimal axis position 94 of the one or more axes of rotation A, B, C.

Since the optimal axis position 94 and thus the optimal measurement direction 98 are used in the recess 96, the measurement direction 59 can be retained along the plurality of measurement points in this example. Thus, the axis of rotation A, B and/or C is changed as little as possible.

FIG. 11 schematically shows the optimization of the position of the reference point 62 or the measurement position of the measurement sensor 12 with reference to the same recess 96 as in FIG. 10. For example, the recess 96 has a depth of t=20 mm. The permissible positions 80 of the reference point 62 for the respective measurement point 56 are in the respective plane E. The normal n of the plane E is oriented perpendicular to the measurement path 68 which runs through the plurality of measurement points 56.

The optimal measurement position of the measurement sensor 12 (not illustrated here) is determined in such a way that the axis position of one or more of the plurality of linear axes X, Y, Z is changed as little as possible in order to move the measurement sensor 12 along the measurement path 68. The corresponding optimal position of the reference point 62 is denoted with the reference sign 100. The optimal measurement path 68′ runs through the respective optimal position 100 of the reference point 62 of the plurality of measurement points 56.

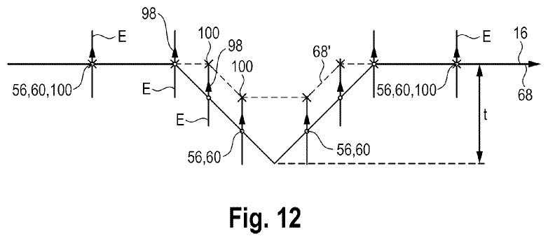

FIG. 12 shows a schematic illustration of the optimization of the position of the reference point 62 or the measurement position of the measurement sensor 12 in the case of the same recess 96 in the measurement object 16 as in FIGS. 10 and 11. In contrast to the example shown in FIG. 11, the measurement position of the measurement sensor 12 is optimized taking into account the optimal measurement direction 98 which was previously determined according to step (iii) of the method 74 (FIG. 10). This corresponds to an optimization of the axis position of at least one axis of rotation A, B, C and a subsequent optimization of the axis position of at least one linear axis X, Y, Z.

In contrast to FIG. 11, in the recess 96 in the measurement object 16, the measurement direction 59 of the measurement sensor 12, which corresponds to an optimal measurement direction 98, deviates from the target measurement direction 58. The plane E, which describes the position tolerance, contains the optimal measurement direction 98. Thus, in comparison with the example shown in FIG. 11, the plane E is tilted at the corresponding measurement points 56 in the recess 96.

The optimal axis position 94 of the one or more axes of rotation A, B, C thus influences the permissible measurement positions 84 of the measurement sensor 12 and thus also the optimal axis position 94 of the one or more linear axes X, Y, Z.

The measurement sensor 12 can then be moved along the measurement path 68 or 68′ according to an optimal measurement direction 98 and an optimal measurement position of the measurement sensor 12, wherein the optimal measurement direction 98 is predefined by the optimal axis position 94 of one or more axes of rotation A, B, C and the optimal measurement position of the measurement sensor 12 is predefined by the optimal axis position 94 of one or more linear axes X, Y, Z.

It goes without saying that the exemplary embodiments shown in the figures show only exemplary configurations of the method according to the invention for controlling the coordinate measuring machine and of the coordinate measuring machine according to the invention, which are intended to illustrate the advantages of the method according to the invention and of the coordinate measuring machine according to the invention.

Various modifications may be made to these exemplary embodiments without departing from the spirit and scope of the present invention. For example, the measurement sensor, which is configured in the present case as an optical measurement sensor, can also be configured as a tactile measurement sensor.

It should be pointed out that the present invention is explained only by way of example with reference to a coordinate measuring machine of gantry design. In principle, however, the invention can also be used, for example, in measurement systems of cantilever, bridge or column design. Depending on the type of measurement system, the relative movement of the measurement object holder and the measurement sensor along one, two or all three spatial directions x, y, z can also be achieved by a movability of the measurement object holder.

Likewise, the measurement system may have any number of linear axes and/or axes of rotation.

By way of example, a positioning device was described, with which the measurement sensor can be positioned relative to the measurement object. Additionally or alternatively, the measurement object can be arranged on a rotary table which can be moved and positioned relative to the measurement sensor.

In the illustrated exemplary embodiment, the measurement position tolerances were specified in relation to the reference point. It goes without saying that, due to the fixed geometric relationship between the reference point and the measurement sensor, the measurement position tolerance applies equivalently to the position of the measurement sensor. The measurement position tolerance can therefore also be specified for the measurement sensor itself.

Furthermore, the permissible positions of the reference point for the respective measurement point may generally be in a three-dimensional shape, such as a circular disk with a predefined thickness. A thickness of the three-dimensional shape (in the direction of the measurement path) can be specified depending on the distance between the measurement points. This avoids overlaps between the permissible positions of the reference point of adjacent measurement points (along the measurement path).

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for controlling a measurement system for determining dimensional and/or geometric properties of a measurement object, wherein the measurement system has a measurement object holder and a measurement sensor, wherein the measurement sensor defines a reference point for measuring the measurement object and can be moved within a measurement volume relative to the measurement object holder along a plurality of movement axes for measuring a plurality of measurement points of the measurement object, the method comprising:
determining at least one of:
a plurality of permissible measurement directions of the measurement sensor for each of the plurality of measurement points based on a target measurement direction for the respective measurement point, wherein the plurality of permissible measurement directions comply with a measurement direction tolerance in relation to the target measurement direction, and
a plurality of permissible measurement positions of the measurement sensor for each of the plurality of measurement points based on a reference point target position for the respective measurement point, wherein, in the plurality of permissible measurement positions of the measurement sensor, the reference point complies with a position tolerance in relation to the reference point target position;
determining a plurality of permissible axis positions of at least one movement axis of the plurality of movement axes for each of the plurality of measurement points based on the permissible measurement directions and/or the permissible measurement positions for the respective measurement point; and
determining an optimal axis position of the at least one movement axis for each of the plurality of measurement points from the plurality of permissible axis positions previously determined for the respective measurement point.

2. The method of claim 1 wherein the target measurement direction of a respective one of the plurality of measurement points and the plurality of permissible measurement directions of the respective one of the plurality of measurement points run through a common point.

3. The method of claim 1 wherein the permissible measurement directions of a respective one of the plurality of measurement points are within a defined envelope cone around the target measurement direction of the respective one of the plurality of measurement points.

4. The method of claim 1 wherein, in the plurality of permissible measurement positions of the measurement sensor, the reference point is in a plane with the respective reference point target position.

5. The method of claim 1 wherein:
the determining of the plurality of permissible axis positions includes determining, for each of the plurality of measurement points, permissible axis positions for at least another one of the plurality of movement axes, and
the determining of the optimal axis position of the at least one movement axis further depends on the permissible axis positions of at least one other movement axis.

6. The method of claim 1 wherein:
the plurality of movement axes include a plurality of axes of rotation,
the determining of the plurality of permissible measurement directions of the measurement sensor includes determining the plurality of permissible measurement directions of the measurement sensor for each of the plurality of measurement points based on the target measurement direction for the respective measurement point,
the determining of the plurality of permissible axis positions includes determining the plurality of permissible axis positions of at least one of the plurality of axes of rotation for each of the plurality of measurement points based on the permissible measurement directions, and
the determining of the optimal axis position of the at least one movement axis includes determining the optimal axis position of the at least one of the plurality of axes of rotation for each of the plurality of measurement points from the plurality of permissible axis positions of the at least one of the plurality of axes of rotation that were previously determined for the respective measurement point.

7. The method of claim 1 wherein:
the plurality of movement axes include a plurality of linear axes,
the determining of the plurality of permissible measurement positions of the measurement sensor includes determining the plurality of permissible measurement positions of the measurement sensor for each of the plurality of measurement points based on a target position for the respective measurement point,
the determining of the plurality of permissible axis positions includes determining the plurality of permissible axis positions of at least one of the plurality of linear axes for each of the plurality of measurement points based on the permissible measurement positions for the respective measurement point, and
the determining of the optimal axis position of the at least one movement axis includes determining the optimal axis position of the at least one of the plurality of linear axes for each of the plurality of measurement points from the plurality of permissible axis positions of the at least one of the plurality of linear axes that were previously determined for the respective measurement point.

8. The method of claim 1 wherein:
the plurality of movement axes include a plurality of linear axes and a plurality of axes of rotation,
the determining of the plurality of permissible measurement directions of the measurement sensor includes determining the plurality of permissible measurement directions of the measurement sensor for each of the plurality of measurement points based on the target measurement direction for the respective measurement point,
the determining of the plurality of permissible measurement positions of the measurement sensor includes determining the plurality of permissible measurement positions of the measurement sensor for each of the plurality of measurement points based on a target position for the respective measurement point,
the determining of the plurality of permissible axis positions includes:
determining the plurality of permissible axis positions of at least one of the plurality of axes of rotation for each of the plurality of measurement points based on the permissible measurement directions, and
determining the plurality of permissible axis positions of at least one of the plurality of linear axes for each of the plurality of measurement points based on the permissible measurement positions for the respective measurement point, and
the determining of the optimal axis position of the at least one movement axis includes:
determining the optimal axis position of the at least one of the plurality of axes of rotation for each of the plurality of measurement points from the plurality of permissible axis positions of the at least one of the plurality of axes of rotation that were previously determined for the respective measurement point, and
determining the optimal axis position of the at least one linear of the plurality of axes for each of the plurality of measurement points from the plurality of permissible axis positions of the at least one of the plurality of linear axes that were previously determined for the respective measurement point.

9. The method of claim 1 further comprising optimizing a movement of the measurement sensor based on the determined optimal axis position of the at least one movement axis for each of the plurality of measurement points.

10. The method of claim 9 wherein the optimizing of the movement of the measurement sensor includes at least one of a time optimization and an optimization of a change in an absolute value of the axis position of the at least one movement axis.

11. The method of claim 9 wherein:
the optimizing of the movement of the measurement sensor includes an optimization of a change in an absolute value of the axis position of the at least one movement axis, and
the optimization includes:
a first condition that the at least one movement axis is moved to a minimum possible extent from one of the measurement points to a subsequent one of the plurality of measurement points, or
a second condition that a total movement of the at least one movement axis along the plurality of measurement points is minimal.

12. The method of claim 9 wherein the optimizing of the movement of the measurement sensor includes a time optimization including:
a first condition that the time required for moving the measurement sensor along the at least one movement axis from one of the measurement points to a subsequent one of the plurality of measurement points is as short as possible, or
a second condition that a total duration required for moving the measurement sensor along the at least one movement axis along the plurality of measurement points is as short as possible.

13. The method of claim 1 further comprising:
determining control data based on the optimal axis position of the at least one movement axis for each of the plurality of measurement points, and
moving the measurement sensor based on the control data.

14. A measurement system for determining dimensional and/or geometric properties of a measurement object, the measurement system comprising:
a measurement object holder;
a measurement sensor that defines a reference point for measuring the measurement object and can be moved within a measurement volume relative to the measurement object holder along a plurality of movement axes for measuring a plurality of measurement points of the measurement object;
a controller that is configured to move the measurement sensor along the plurality of movement axes based on control data; and
a processor that is configured to determine the control data by:
determining at least one of:
a plurality of permissible measurement directions of the measurement sensor for each of the plurality of measurement points based on a target measurement direction for the respective measurement point, wherein the plurality of permissible measurement directions comply with a measurement direction tolerance in relation to the target measurement direction for the respective measurement point, and
a plurality of permissible measurement positions of the measurement sensor for each of the plurality of measurement points based on a reference point target position for the reference point for the respective measurement point, wherein, in the plurality of permissible measurement positions of the measurement sensor, the reference point complies with a position tolerance in relation to the reference point target position;
determining a plurality of permissible axis positions of at least one movement axis of the plurality of movement axes for each of the plurality of measurement points based on the permissible measurement directions and/or the permissible measurement positions for the respective measurement point; and
determining an optimal axis position of the at least one movement axis for each of the plurality of measurement points from the plurality of permissible axis positions previously determined for the respective measurement point.

15. The measurement system of claim 14 further comprising:
an interface for receiving parameters that define, for each of the plurality of measurement points, at least one of the target measurement direction, the reference point target position, the measurement direction tolerance, and the position tolerance, and
a memory that stores the parameters.

16. A non-transitory computer-readable medium comprising instructions that are executed on a processor of a measurement system to determine dimensional and/or geometric properties of a measurement object, wherein the measurement system has a measurement object holder and a measurement sensor, wherein the measurement sensor defines a reference point for measuring the measurement object and can be moved within a measurement volume relative to the measurement object holder along a plurality of movement axes for measuring a plurality of measurement points of the measurement object, the instructions including:
determining at least one of:
a plurality of permissible measurement directions of the measurement sensor for each of the plurality of measurement points based on a target measurement direction for the respective measurement point, wherein the plurality of permissible measurement directions comply with a measurement direction tolerance in relation to the target measurement direction, and
determining a plurality of permissible measurement positions of the measurement sensor for each of the plurality of measurement points based on a reference point target position for the respective measurement point, wherein in the plurality of permissible measurement positions of the measurement sensor the reference point complies with a position tolerance in relation to the reference point target position;
determining a plurality of permissible axis positions of at least one movement axis of the plurality of movement axes for each of the plurality of measurement points based on the permissible measurement directions and/or the permissible measurement positions for the respective measurement point; and
determining an optimal axis position of the at least one movement axis for each of the plurality of measurement points from the plurality of permissible axis positions previously determined for the respective measurement point.
